(19) United States
(12) Patent Application Publication
(10) Pub. No.: US 2023/0038244 A1
(43) Pub. Date: Feb. 9, 2023

(54) DEVICE FOR ANALYSING A SET OF FOOD PARTICLES AND METHOD THEREOF

(71) Applicant: NEOVIA, SAINT-NOLFF (FR)

(72) Inventors: Mikaël MARZIN, MORÉAC (FR); Vincent SINCHOLLE, VANNES (FR); Valérie BLANC, REZÉ (FR)

(21) Appl. No.: 17/786,953

(22) PCT Filed: Dec. 17, 2020
(86) PCT No.: PCT/FR2020/052505

§ 371 Date: Aug. 15, 2022

(30) Foreign Application Priority Data
Dec. 19, 2019 (FR) FR1914955

(51) Int. Cl. G06T 7/90; G06T 7/00; G06T 7/13; G01N 33/02

(52) U.S. Cl. CPC G06T 7/90; G06T 7/0006; G06T 7/13; G01N 33/02; G06T 2207/10024; G06T 2207/30128

(57) ABSTRACT

The present invention relates to a method for analysing a set of food particles, comprising the steps of acquiring a digital colour image of a plurality of particles arranged on a substrate, detecting portions of the image corresponding to each particle, determining the colour of each portion of the determined image, and measuring a distance between the determined colour of one portion of the image and a predetermined colour of a predetermined particle type.

### FIELD OF THE INVENTION

The present invention relates to food, and more particularly to the field of monitoring the manufacture of particles for food. It relates in particular to a method for analyzing food particles, as well as a system for implementing such a method.

### STATE OF THE ART

Food particles, particularly pellets for food, comprise food materials, for example compacted and/or dehydrated. Food particles, for example in the form of pellets, have the advantage of being less dusty than powder or flour. During the production of food particles, it is desirable to monitor the quality of each of the particles following the production of a batch of particles.

To this end, document FR 3049374 describes a method for measuring the size of food particles, comprising a step of acquiring a digital image of the particles, then a step of processing the acquired image, making it possible to identify the contours of each of the particles. Thus, it is possible to monitor, to some extent, the dimensions of the particles of the batch.

However, this method does not allow monitoring the internal composition of each of the particles.

### DISCLOSURE OF THE INVENTION

One aim of the invention is to propose a solution for analyzing a set of food particles, and particularly for monitoring the internal composition of each of the particles of the set.

This aim is achieved within the framework of the present invention thanks to a method for analyzing a set of food particles, comprising the steps of:

a) acquiring a digital color image of a plurality of particles disposed on a carrier,

b) detecting portions of the image corresponding to each particle,

c) determining the color or the color spectrum of each portion of the image determined during step b),

d) measuring a distance between the color or the color spectrum determined during step c) of a portion of the image and between a predetermined color or a predetermined color spectrum of a predetermined type of particle.

The invention is advantageously completed by the following characteristics, taken individually or in any one of their technically possible combinations:
the set of particles is a composition of several types of particles, and the composition of the set of particles is determined, the method in accordance with the invention comprising:
a step e), subsequent to step d), of associating each color or each color spectrum determined during step c) with a type of particle chosen among a set of predetermined types of particles as a function of a minimization of the distance calculated during step c), then
a step f) of calculating the composition of the set as a function of each of the types of particles associated during step e),
during the image acquisition step a), the colors of the image are recorded:
according to parameters representative of the hue, saturation and value of the colors, and/or
according to parameters representative of the hue, saturation and lightness of the colors,
the method in accordance with the invention comprises a step of:

a′) acquiring a digital color image of at least one control particle disposed on the carrier, step a′) being preferably concomitant with step a), and
during step d), the predetermined color or the predetermined color spectrum of the type of particles is the color or the color spectrum of the control particle determined during step c),
the digital detection step b) comprises:

i) a sub-step of transforming the color image into a grayscale image, then

ii) a sub-step of thresholding the grayscale image obtained during the previous sub-step, then

iii) a sub-step of detecting the contours of the portions of the image corresponding to each particle from the image obtained during the previous thresholding sub-step,
during the acquisition step a), the particles are imaged against a blue background, preferably against a background emitting or reflecting light waves having only one or several wavelengths comprised between 466 nm and 490 nm,
the method in accordance with the invention comprises:
a step g) of rotating each of the particles by an angle comprised between 70° and 110°, then of immobilizing the pellets at this angle opposite the carrier, and
a repetition of the acquisition a) and detection b) steps,
an alert is issued if the distance measured during step d) is greater than a predetermined distance.

Another aspect of the invention is a system for analyzing a set of food particles, comprising:
a carrier adapted to support a plurality of particles,
an imaging system adapted to image in colors the particles,
a monitoring unit connected to the imaging system,

the monitoring unit being configured to:
control the acquisition of a digital color image of a plurality of particles disposed on the carrier,
detect portions of the image corresponding to each particle,
determine the color or the color spectrum of each portion of the image,
measure a distance between the determined color or color spectrum of a portion of the image and between a predetermined color or a predetermined color spectrum of a predetermined type of particle.

Advantageously, the imaging system is a scanner, the scanner comprising the carrier and the carrier being transparent to light.

### DESCRIPTION OF THE FIGURES

Other characteristics, aims and advantages of the invention will emerge from the following description, which is purely illustrative and not limiting, and which should be read in relation to the appended drawings in which:

FIG. 1 schematically illustrates a system in accordance with the invention,

FIG. 2 schematically illustrates a method in accordance with the invention,

FIG. 3 schematically illustrates an image acquired by a system in accordance with the invention.

In all the figures, similar elements bear identical references.

### Definitions

It is known, in order to digitally store information relating to the colors of an image, to use the RGB (red, green and blue) system. In this system, the data representative of the color of a pixel comprise the values of each of the red, green and blue colors.

It is also known, in order to digitally store information relating to the colors of an image, to use the HSL (hue, saturation, lightness) system or the HSV (hue, saturation, value) system. In this system, the data representative of the color of a pixel comprise values of the hue, saturation and lightness (or value).

### DETAILED DESCRIPTION OF THE INVENTION

### System 8 for Analyzing Particles 1

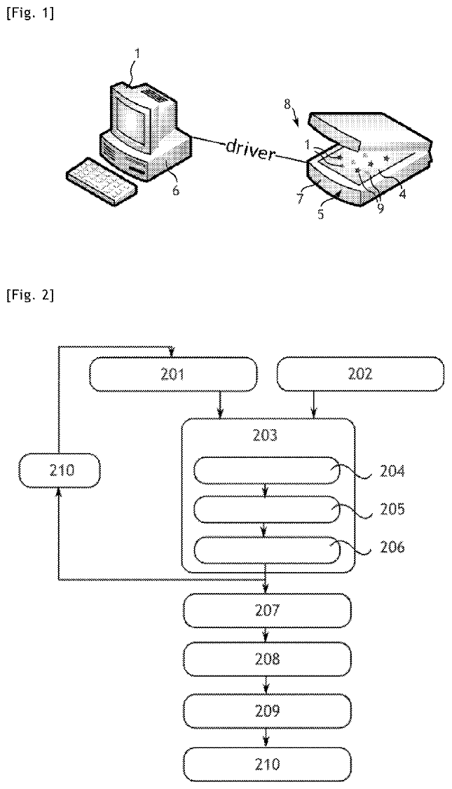

With reference to FIG. 1, a system 8 for analyzing a set of food particles 1 in accordance with the invention comprises a carrier 4. The carrier 4 is adapted to support a plurality of particles 1, which can for example be disposed on the carrier 4 before the analysis. The particles 1 can be disposed on the carrier 4 directly, i.e. in contact with the carrier 4, or preferably indirectly, a device comprising the particles being itself directly in contact with the carrier, and the particles being immobilized in the device. In this case, at least part of the device is transparent to visible light, so as to allow the imaging of the particles.

The system 8 comprises an imaging system 5 adapted to image in colors the particles 1. The imaging system 5 can comprise an optical system, for example equipped with an image sensor CCD.

The system 8 also comprises a monitoring unit 6 connected to the imaging system. The monitoring unit 6 is adapted to receive the data representative of the color images acquired by the imaging system 5.

Preferably, the system 8 comprises a scanner 7, the scanner 7 comprising itself the imaging system 5 and the carrier 4. The carrier 4 is preferably transparent to visible light, then making it possible to dispose the particles 1 on one side of the carrier 4, and to arrange the imaging system 5 on the other side of the carrier 4.

### Method for Analyzing a Set of Particles 1

With reference to FIG. 2, a method for analyzing a set of particles 1 in accordance with the invention comprises a step 201 of acquiring a digital color image 2 of a plurality of particles 1 disposed on the carrier 4. Each of the particles 1 being arranged in a plane on the carrier 4, or parallel to the carrier 4, it is possible to image the set of the particles 1 simultaneously.

The particles 1 disposed on the carrier 4 can be the set of particles 1 to be analyzed, and/or control particles 9.

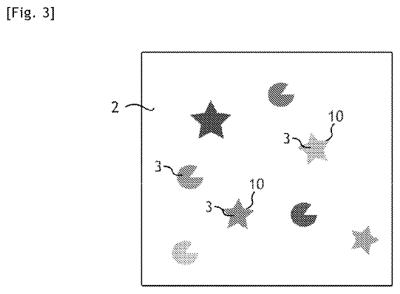

With reference to FIG. 3, a method in accordance with the invention preferably comprises a step 202 of acquiring a digital color image 2 of at least one control particle 9 disposed on the carrier 4. Steps 201 and 202 can be successive, or preferably concomitant. It is for example possible to dispose particles 1 to be analyzed and control particles 9 on the same carrier 4, and to image the particles so as to obtain a single color image comprising the images of the particles 1 to be analyzed and control particles 9. The monitoring unit 6 can also comprise a memory, the memory comprising color images of control particles 9.

Preferably, the system 8 comprises an opaque screen arranged on the opposite side to the imaging system 5, adapted to serve as a background for the image acquired during step 201 and/or 202. The color of the opaque screen is preferably blue. By blue, it is meant blue according to the AFNOR X08-010 standard, i.e. emitting or reflecting light waves with a wavelength comprised between 466 nm and 490 nm. Thus, it is possible, during the imaging of the particles 2, to facilitate the recognition of the contours 10 of the particles 2 by a computer processing. Indeed, the inventors measured that the color furthest chromatically from the food particles, on average, was blue.

A method in accordance with the invention also comprises a step 203 of detecting the portions 3 of the image corresponding to each particle 1. To this end, the monitoring unit 6 can comprise a main program that allows monitoring the implementation of the method in accordance with the invention. The main program can for example be a program in Python language. The main program can use a library, allowing the main program to recognize the contours 10 in the image acquired during step 201 and/or step 202. Thus, it is possible to detect the portions 3 of the image corresponding to each of the particles 1 or the control particles 9. The library used can be a library of the OpenCV (Open Computer Vision) type.

The step 203 of detecting the portions 3 preferably comprises a sub-step 204 of transforming the color image into a grayscale image, then a sub-step 205 of thresholding the grayscale image obtained during the sub-step 204, then a sub-step 206 of detecting the contours 10 of the portions 3 of the image corresponding to each particle 1 from the image obtained during the previous thresholding sub-step. Thus, it is possible to detect the contours 10 of the image from the sole variations in the light intensity. Different methods can be used to detect the portions 3 in step 203, such as the use of a Prewitt filter, a Sobel filter or a Canny filter.

A method in accordance with the invention comprises, following step 203, a step 207 of determining the color or the color spectrum of each portion 3 of the image 2 determined during step 203. During step 203, the monitoring unit 6 records in a file the data representative of the color of each pixel of the image 2 comprised in a portion 3 detected during step 203. All of these data allow establishing, for a determined portion 3, corresponding to a determined particle 1 or to a determined control particle 9, the spectrum of the colors of said portion 3. The monitoring unit 6 can also calculate, from the determined color spectrum, an average color of the portion 3 representative of the particle. The data representative of the color of each pixel of the image 2 can be stored in the monitoring unit 6 in the RGB and/or HSV formats defined above.

A method in accordance with the invention also comprises a step 208 of measuring a distance between the color or the color spectrum determined during step 207 of the portion(s) 3 of the image 2 and between a predetermined color or a predetermined color spectrum of a predetermined type of particle 1. Preferably, the color or the predetermined color spectrum of the type of particle 1 is the color or the color spectrum of the control particle 9 determined during step 207.

It is meant by the term “distance” the distance in the mathematical sense, i.e. any mathematical application defined on the product of two sets and with a value in the set of the positive real numbers, meeting the properties of symmetry, separation and triangle inequality. During the implementation of step 208, the distance can be preferably a Manhattan, Euclidean, Minkowski and/or Chebyshev distance. The distance can be for example calculated between a vector of values representative of the color spectrum of a portion 3 and between a set of values representative of a single predetermined color, or between two vectors of values representative of the color spectrum of two different portions 3. Thus, it is possible to measure a deviation between the color of one or several particles 1 to be analyzed and the color of one or several control particles 9, this deviation being representative of a difference in the internal composition between the particle(s) to be analyzed and the control particle(s) 9. It is thus possible to analyze the set of the particles 1.

The method in accordance with the invention preferably comprises a step 209 subsequent to step 208 of associating each color or each color spectrum determined during step 207 with a type of particle 1 chosen among a set of predetermined types of particle 1 in step 208. It is thus possible to recognize whether the particle 1 to be analyzed is a particle 1 of a known type.

The association of step 209 can be implemented by a thresholding of the distance calculated during step 208: if the distance calculated during step 208 is smaller than a predetermined value, then the particle 1 to be analyzed is associated, whose color or color spectrum has been determined during step 207, with the predetermined type of particle 1 in step 208. If the calculated distance is strictly greater than the predetermined value, then this association is not implemented. In this case, it is not possible to associate the particle 1 to be analyzed with a known particle. Then, preferably, an alert can be issued to the user, by any known machine-man interface means.

When the RGB format is used to store the data representative of the color of each pixel, the calculation of the distance between two pixels can comprise a calculation of the deviation between each of the red, green and blue components of each of the pixels. If one of the calculated deviations is greater than the predetermined threshold value, for example by a value equal to 10 during a 256-level encoding, the association is not implemented.

However, the thresholding carried out on each of the R, G and B components does not allow obtaining results that allow perfectly distinguishing, in all the tests, two particles of neighboring but different colors.

The HSV system can be preferentially used to solve this problem. Indeed, one of the components of the HSV system is the hue (H of HSV). During step 201, and in particular during steps 201 and 202, the colors of the image are preferably recorded according to parameters representative the hue, saturation and value of the colors, and/or according to parameters representative of the hue, saturation and lightness of the colors. Thus, it is possible to implement a thresholding on a single component of the color of a pixel, preferably on the hue, which allows associating a particle 1 to be analyzed with a predetermined type of particle more accurately than when using another color representation system. Indeed, as one of the components is the hue, it is possible not to take into account, in the thresholding of the characteristics of the portion 3, the components which have no link with the type of particle 1 considered, like light, the exposure, which are components that are statistically related more importantly to the imaging method than to the internal composition of a particle.

The method in accordance with the invention can preferably allow calculating the composition of the set of particles 1, in proportion to the type of predetermined particles. The association step 209 is then applied to each of the portions 3 corresponding to a particle 1 to be analyzed. Preferably, in combination with a thresholding or not, the step 209 can comprise a minimization of the distance calculated during step 207, the minimization being carried out on the set of the distances calculated for a set of predetermined colors or predetermined color spectrum of a predetermined type of particle 1. Thus, it is possible to calculate which type of predetermined particle the particle 1 to be analyzed is closest to. The method comprises a step 210 of calculating the composition of the set as a function of each of the types of particles 1 associated during step 209.

A method in accordance with the invention can also comprise, as a variant of step 208 or in combination, a step of measuring distances between the colors or the color spectra of the particles 1 to be analyzed together. It is then necessary to enter the number of predetermined types of particles. It is thus possible to calculate the distribution of the particles 1 without using a predetermined color or color spectrum.

A method in accordance with the invention can also comprise a step 210, at least subsequent to the step 201 of acquiring the digital image 2, rotating each of the particles 1 by an angle comprised between 70° and 110°, then immobilizing the pellets at this angle opposite the carrier. Thus, it is possible to measure three dimensions of each particle 1 to be analyzed, which allows a more accurate association of the type of particle to be analyzed with a predetermined type of particle. Furthermore, the quality control of a particle 1 to be analyzed can thus be more accurate. A repetition of steps 201 and 202 is then implemented, to acquire a color image of the particles from another angle than during the first step 201, and to determine the different corresponding portions 3. Preferably, the rotation of each of the particles can be implemented along an axis of rotation different from an axis perpendicular to the carrier. In particular, the rotation of each of the particles can be implemented along an axis of rotation parallel to the carrier.

1. A method for analyzing a set of food particles, the method comprising the steps of:
a) acquiring a digital color image of a plurality of particles disposed on a carrier,
b) detecting portions of the image corresponding to each particle,
c) determining a color or a color spectrum of each portion of the image determined during step b), and
d) measuring a distance between the color or the color spectrum determined during step c) of the portion of the image and between a predetermined color or a predetermined color spectrum of a predetermined type of particle.

2. The method according to claim 1, wherein the set of particles is a composition of several types of particles, and wherein the composition of the set of particles is determined,
the method comprising:
a step e), subsequent to step d), of associating each color or each color spectrum determined during step c) with a type of particle chosen among a set of predetermined types of particles as a function of a minimization of the distance calculated during step c), then
a step f) of calculating a composition of the set as a function of each of the types of particles associated during step e).

3. The method according to claim 1, wherein, during the image acquisition step a), the colors of the image are recorded:
according to parameters representative of a hue, saturation and value of the colors, and/or
according to parameters representative of a hue, saturation and lightness of the colors.

4. The method according to claim 1, comprising a step of:
a′) acquiring a digital color image of at least one control particle disposed on the carrier,
during step d), the predetermined color or the predetermined color spectrum of the type of particles is the color or the color spectrum of the control particle (9) determined during step c).

5. The method according to claim 1, wherein the digital detection step b) comprises:
i) a sub-step of transforming the color image into a grayscale image, then
ii) a sub-step of thresholding the grayscale image obtained during the previous sub-step, then
iii) a sub-step of detecting contours of the portions of the image corresponding to each particle from the image obtained during the previous thresholding sub-step.

6. The method according to claim 1, wherein, during the acquisition step a), the particles are imaged against a blue background.

7. The method according to claim 1, further comprising:
a step g) of rotating each of the particles by an angle comprised between 70° and 110°, then of immobilizing the pellets at this angle opposite the carrier, and
a repetition of the acquisition step a) and detection step b).

8. The method according to claim 1, wherein an alert is issued if the distance measured during step d) is greater than a predetermined distance.

9. A system for analyzing a set of food particles, comprising:
a carrier configured to support a plurality of particles,
an imaging system configured to image in colors the particles, and
a monitoring unit connected to the imaging system,
the monitoring unit being configured to:
control acquisition of a digital color image of a plurality of particles disposed on the carrier,
detect portions of the image corresponding to each particle,
determine a color or a color spectrum of each portion of the image, and
measure a distance between the determined color or color spectrum of a portion of the image and between a predetermined color or a predetermined color spectrum of a predetermined type of particle.

10. The system according to claim 9, wherein the imaging system is a scanner, the scanner comprising the carrier and the carrier being transparent to light.

11. The method according to claim 4, wherein step a′) is concomitant with step a).

12. The method according to claim 6, wherein, during the acquisition step a), the particles are imaged against a background emitting or reflecting light waves having only one or several wavelengths comprised between 466 nm and 490 nm.
